(19) United States
(12) Patent Application Publication
(10) Pub. No.: US 2009/0180279 A1
(43) Pub. Date: Jul. 16, 2009

(54) POWER CORD MOUNTED ELECTRONIC MODULE FOR PORTABLE LAMP

(76) Inventors: JOSEPH BOBBIN, Nanticoke, PA (US); John Devaney, Mountain Top, PA (US); Mark Dirsa, Shaverton, PA (US)

Correspondence Address: PATENT GROUP;C/O DLA PIPER US LLP, 203 N. LASALLE ST., SUITE 1900, CHICAGO, IL, 60601, US

(21) Appl. No.: 12/351,618

(22) Filed: Jan. 9, 2009

Related U.S. Application Data
(60) Provisional application No. 61/020,518, filed on Jan. 11, 2008.

(51) Int. Cl. F21V 21/084; F21L 4/00

(52) U.S. Cl. 362/106; 362/190

(57) ABSTRACT

A cap lamp system features a battery pack, a cap lamp housing containing a cap lamp bulb and a power cord connected between the battery pack and the cap lamp housing. The power cord provides power to the cap lamp bulb from the battery pack. An electronic module includes a housing defining a chamber and electronic circuitry is positioned within the chamber of the housing. The electronic module is positioned in circuit with the power cord. The electronic module may receives power from the battery pack and the electronic circuitry of the electronic module may includes a battery that powers the module.

### CLAIM OF PRIORITY

This application claims priority from U.S. Provisional Patent Application Ser. No. 61/020,518, filed Jan. 11, 2008, currently pending.

### FIELD OF THE INVENTION

The present invention relates to portable lamps such as cap lamps and other portable light sources and, more particularly, to an electronic module that is mounted on a power cord running between a battery pack and a cap lamp or other portable lighting source.

### BACKGROUND

Mining cap lamps are typically mounted on hard hats worm by miners to provide illumination in underground mine shafts. Such cap lamps are well known in the mining equipment industry and provide illumination while the miner's hands remain free to perform tasks. A cap lamp typically receives power from a battery power pack secured to the user's waist. An electrical power cord delivers power from the power pack to the lamp on the helmet.

Modern day mines often include a miner tracking system so that the location of miners may be tracked for safety purposes. Such systems often include sensors positioned throughout the mine shafts. A miner wears a radio frequency identification (RFID) tag which broadcasts a signal including the identify of the miner wearing the RFID tag. When the miner passes a miner tracking system sensor, the sensor receives the signal from the RFID tag. The sensors communicate with a central computer which tracks the location of miners wearing the RFID tags based on which sensors have received signals from the miners' RFID tags.

The RFID tags must receive electrical power to operate. Traditionally, wires have been soldered to the battery terminals of the cap lamp power pack and to the RFID tags so that the RFID tags receive power from the battery of the cap lamp power pack. A problem with such an arrangement, however, is that such modifications are time consuming and inconvenient. In addition, and more importantly, the quality of the soldered connections is often inconsistent which leads to reliability issues, especially in the harsh mining environment. The exposed wires of such a power takeoff are also exposed which makes them even more vulnerable to damage.

Furthermore, additional devices or modules that are powered by electricity may be useful if carried by a worker in a mine or other harsh environment. Such devices include, but are not limited to, communication devices, gas sensors and dust sensors.

A need therefore exists for a system or device whereby electronic modules such as RFID tags, communication devices, gas sensors, dust sensors other electronic devices may be securely and safely mounted to miners, rescue workers or other individuals.

### BRIEF DESCRIPTION OF THE DRAWINGS

FIG. 1 is a perspective view of a cap lamp system including an embodiment of the electronic module of the present invention;

FIG. 2 is a schematic of the electronic module of FIG. 1 and portions of the power cord;

FIG. 3 is a schematic of a second embodiment of the electronic module of the present invention;

FIG. 4 is a schematic of an on-board battery-powered embodiment of the electronic module of the present invention;

FIG. 5 is an exploded perspective view of the electronic module of FIG. 4.

### DETAILED DESCRIPTION OF EMBODIMENTS

While the invention is described below in terms of use with a battery, cap lamp and helmet for mining, it is to be understood that it may be applied to other types of portable lighting and head gear.

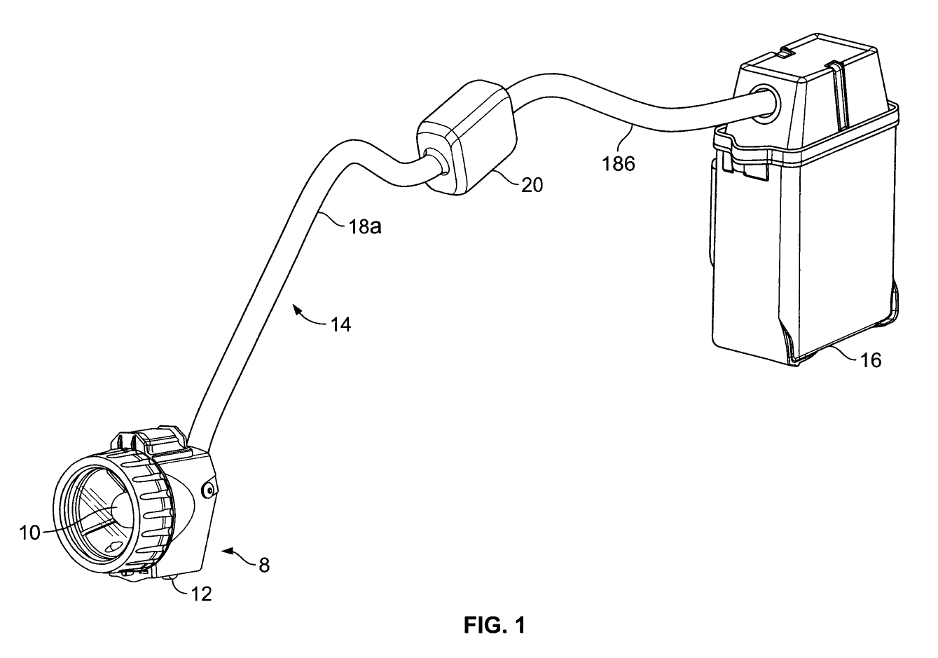

A cap lamp is indicated in general at 8 in FIG. 1. As is illustrated, for example, in U.S. Pat. No. 4,481,458 to Lane, the cap lamp may be mounted on a helmet of the type used in mining. The cap lamp includes a bulb 10 positioned within a housing 12. As an example only, the cap lamp may be a model Mark V cap lamp sold by Koehler-Bright Star, Inc. of Hanover Township, Pa., who is assignee of the present application. The cap lamp 8 is typically mounted to a front panel of the helmet by a clip or other fastener positioned on the back side of the cap lamp (not shown in FIG. 1). As a result, the cap lamp may be removed from the helmet for recharging or servicing.

The cap lamp 8 receives power via a power cord, indicated in general at 14, that provides power to the cap lamp from a battery pack 16. The battery pack is typically worn strapped to the waist of the miner or in another location. As an example only, the battery pack may be a model Li-16 battery pack sold by sold by Koehler-Bright Star, Inc. of Hanover Township, Pa., who is assignee of the present application.

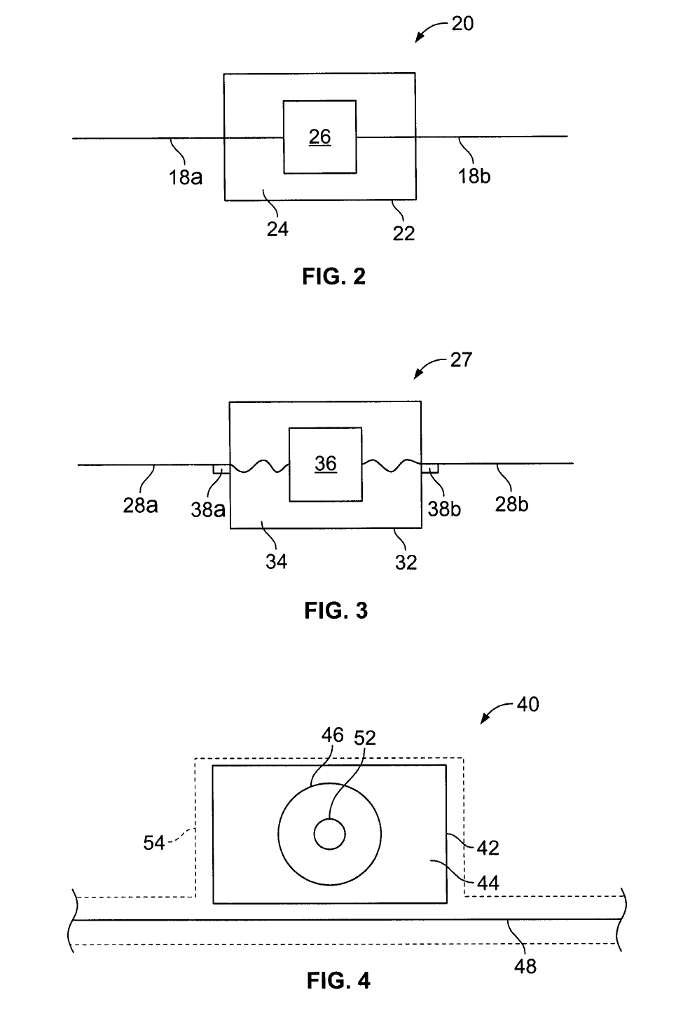

As is illustrated in FIGS. 1 and 2, the power cord 14 features two segments or portions 18a and 18b. As illustrated in FIGS. 1 and 2, an electronic module 20 is positioned in circuit with the segments 18a and 18b of the power cord. As illustrated in FIG. 2, the electronic module features a housing 22 which defines a chamber 24 within which is positioned electronic circuitry 26. In this embodiment, and in the additional embodiments described below, the electronic circuitry may be a radio frequency identification tag (RFID) tag, communication device, gas sensor, dust sensor or any other electronic device that may be useful if carried by a miner or other worker. In this embodiment and the embodiments described below, the housing 22 preferably is molded or otherwise constructed out of plastic and features an opening that is sealed with a gasketed cover once the electronic circuitry 26 is positioned within chamber 24. Other durable materials may be used instead for constructing the housing. The electronic circuitry 26 receives power from the power cord segments 18a and 18b and also allows power to travel to the cap lamp.

A second embodiment of the electronic module is presented in FIG. 3. Like the embodiment of FIGS. 1 and 2, this electronic module 27 uses a power cord featuring segments 28a and 28b and includes a housing 32 defining a cavity 34 within which electronic circuitry 36 is positioned. As in the case of the embodiment of FIGS. 1 and 2, the electronic circuitry 36 is powered by the power cord segments and allows power to travel to the cap lamp. In the embodiment of FIG. 3, however, the segments 28a and 28b are removably connected to the housing via connectors 38a and 38b, respectively. As a result, the electronic module may be removed from the power cord and the two segments 28a and 28b fastened together via connectors 38a and 38b. As a result, the electronic module may be removed from being in circuit between the cap lamp and the battery pack.

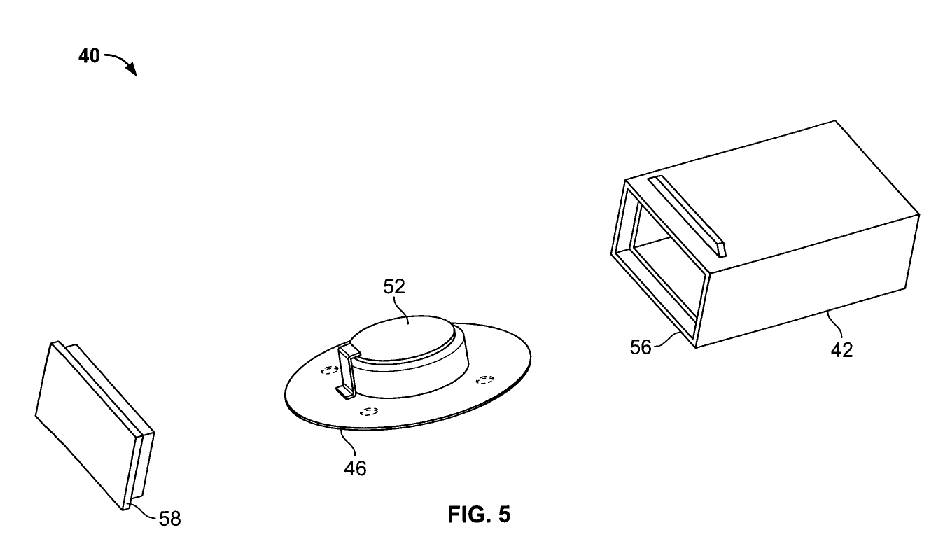

An embodiment of the electronic module that is powered by an on-board battery is illustrated in FIGS. 4 and 5. With reference to FIG. 4, the electronic module 40 features a housing 42 which defines a chamber 44 within which is positioned electronic circuitry 46. In the case of this embodiment, however, the power cord 48 does not power the electronic module. Instead, the electronic module features an on-board battery 52 which powers the electronic circuitry. The electronic module, never-the-less, is still positioned on the power cord 48. A protective coating of rubber, plastic or some other flexible, protective material is indicated in phantom at 54 in FIG. 4 covers the electronic module 40 and power cord 48. This same coating is present in the embodiment of FIGS. 1 and 2 and is visible in FIG. 1.

An exploded perspective view of the electronic module, which is indicated in general at 42, is provided in FIG. 5. As in previous embodiments, the housing 42 preferably is molded or otherwise constructed out of plastic and features an opening 56 that is sealed with a gasketed cover 58 once the electronic circuitry 46 and battery 52 are positioned within the housing chamber. Once the housing and cover are assembled, with the electronic circuitry and battery positioned inside, the electronic module may be covered with the protective coating 54 of FIG. 4.

As noted previously, the construction described with regard to FIGS. 4 and 5 may be used with the embodiments of FIGS. 1-3

While the electronic circuitry may be a powered or self-powered electronic device, such as a printed circuit board with or without a coin cell battery, the electronic module may act as a mounting point (like a docking station) and/or power source, for a variety of interchangeable electronic devices. This is true whether the electronic module includes batteries or not. In the case of no batteries, the “docked” removable electronic device could receive power from the power cord.

While the preferred embodiments of the invention have been shown and described, it will be apparent to those skilled in the art that changes and modifications may be made therein without departing from the spirit of the invention, the scope of which is defined by the appended claims.

What is claimed is:

1. A cap lamp system for a mining helmet comprising:
a) a battery pack;
b) a cap lamp housing containing a cap lamp bulb;
c) a power cord connected between the battery pack and the cap lamp housing, said power cord providing power to the cap lamp bulb from the battery pack;
d) an electronic module including a housing defining a chamber and electronic circuitry positioned within the chamber of the housing; and
e) said electronic module positioned in circuit with the power cord.

2. The cap lamp system of claim 1 wherein the electronic module receives power from the battery pack.

3. The cap lamp system of claim 2 wherein the electronic circuitry of the electronic module includes a battery that powers the module.

4. The cap lamp system of claim 1 wherein the electronic circuitry is an electronic communications tag.

5. The cap lamp system of claim 4 wherein the electronic communications tag is a Radio Frequency identification tag.

6. The cap lamp system of claim 1 wherein the electronic circuitry is a gas sensor.

7. The cap lamp system of claim 1 wherein the electronic circuitry is a dust sensor.

8. The cap lamp system of claim 1 wherein the module features a coating.

9. The cap lamp system of claim 8 wherein the coating is rubber.

10. A cap lamp system for a mining helmet comprising:
a) a battery pack;
b) a cap lamp housing containing a cap lamp bulb;
c) a power cord connected between the battery pack and the cap lamp housing, said power cord providing power to the cap lamp bulb from the battery pack;
d) an electronic module including a housing defining a chamber and electronic circuitry positioned within the chamber of the housing; and
e) said electronic module positioned on the power cord.

11. The cap lamp system of claim 10 wherein the electronic module receives power from the battery pack.

12. The cap lamp system of claim 1 wherein the electronic circuitry of the electronic module includes a battery that provides power to the module.

13. The cap lamp system of claim 10 wherein the electronic circuitry is an electronic communications tag.

14. The cap lamp system of claim 13 wherein the electronic communications tag is a Radio Frequency identification tag.

15. The cap lamp system of claim 10 wherein the electronic circuitry is a gas sensor.

16. The cap lamp system of claim 10 wherein the electronic circuitry is a dust sensor.

17. The cap lamp system of claim 10 wherein the module features a coating.

18. The cap lamp system of claim 17 wherein the coating is rubber.

19. A portable lighting system comprising:
a) a battery pack;
b) a lamp housing containing a lamp bulb;
c) a power cord connected between the battery pack and the lamp housing, said power cord providing power to the lamp from the battery pack;
d) an electronic module including a housing defining a chamber and electronic circuitry positioned within the chamber of the housing; and
e) said electronic module positioned on the power cord.

20. The portable lighting system of claim 19 wherein the electronic module receives power from the battery pack.

21. The portable lighting system of claim 19 wherein the electronic circuitry of the electronic module includes a battery that provides power to the module.

22. The portable lighting system of claim 19 wherein the electronic circuitry is an electronic communications tag.

23. The portable lighting system of claim 22 wherein the electronic communications tag is a Radio Frequency identification tag.

24. The portable lighting system of claim 19 wherein the electronic circuitry is a gas sensor.

25. The portable lighting system of claim 19 wherein the electronic circuitry is a dust sensor.

26. The portable lighting system of claim 19 wherein the module features a coating.

27. The portable lighting system of claim 26 wherein the coating is rubber.

28. A power transfer device for a portable lighting system comprising:
a) a power cord adapted to be connected between a battery pack and a portable lamp, so that said power cord providing power to the portable lamp;
b) an electronic module including a housing defining a chamber and electronic circuitry positioned within the chamber of the housing; and
c) said electronic module positioned on the power cord.

29. The power transfer device of claim 28 wherein the electronic module receives power from the battery pack.

30. The power transfer device of claim 28 wherein the electronic circuitry of the electronic module includes a battery that provides power to the module.

31. The power transfer device of claim 28 wherein the electronic circuitry is an electronic communications tag.

32. The power transfer device of claim 31 wherein the electronic communications tag is a Radio Frequency identification tag.

33. The power transfer device of claim 28 wherein the electronic circuitry is a gas sensor.

34. The power transfer device of claim 28 wherein the electronic circuitry is a dust sensor.

35. The power transfer device of claim 28 wherein the module features a rubber coating.
